(19) United States
(12) Patent Application Publication
(10) Pub. No.: US 2004/0206753 A1
(43) Pub. Date: Oct. 21, 2004

(54) Observation window for a chamber exposed to microwaves

(76) Inventor: Kurt Schaupert, Hofheim (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/782,392

(22) Filed: Feb. 18, 2004

(30) Foreign Application Priority Data
Feb. 19, 2003 (DE) 103 06 882.1

(51) Int. Cl. H05B 6/76

(52) U.S. Cl. 219/740

(57) ABSTRACT

An observation window for a chamber exposed to microwaves, having a support frame and at least one transparent cover plate affixed thereto for closing off the chamber. The at least one cover plate is covered on at least one side with a metallic screen which is impenetrable to microwaves. The screen is movably seated with respect to the support frame and, to increase the ability to view through it, the screen can be put into motion by a drive mechanism.

### BACKGROUND OF THE INVENTION

1. Field of the Invention

This invention relates to an observation window for a chamber exposed to microwaves, having a support frame and at least one transparent cover plate affixed thereto for closing off the chamber, wherein the at least one cover plate is covered on at least one side with a metallic screen which is impenetrable to microwaves.

2. Discussion of Related Art

From the prior art it is known to provide observation windows for microwave devices, such as a cooking apparatus, for example, in order to observe the status of the material to be cooked without a need to open the door of the microwave device. Because microwave radiation can cause health hazards to the user, and for keeping the radiation inside the cooking chamber, it is customary to attach a metal plate, which has holes with a diameter of approximately 1 mm, to the observation window as a shield against radiation. The view of the interior is hampered by the strips between the holes and such a screen interferes, in particular, with the observation of fine details in the cooking chamber.

It is known from German Patent Reference DE 32 31 516 A1 to equip the pane of the observation window with electrically conductive transparent layers for shielding against microwaves. However, placing such layers on the pane is very elaborate and considerably increases the manufacturing costs of a microwave device.

### SUMMARY OF THE INVENTION

It is one object of this invention to provide an observation window for a chamber exposed to microwaves which makes it possible to see even small details within the chamber. Also, the observation window in accordance with this invention is intended to be simple and cost-effective to manufacture.

This object is attained by an invention as described in this specification and the claims.

Accordingly, the screen is seated movably with respect to the support frame. In order to increase the ability to view through it, the screen can be put into motion by a drive mechanism. With a screen moved in this way, the human eye hardly notices the interference with the view caused by the strips between the holes in the screen, so that small details also become recognizable.

In a cost-effective manner, the screen can be embodied as a lattice grid, a metal plate with a grid of holes cut into it, or as a similar open-worked flat arrangement.

To satisfy demands made on the design of modern kitchen apparatus, the screen and/or the cover plate and/or the support frame can be rectangular, round or have other arbitrary forms, at least in parts.

For increasing the ability to view through it, the screen can be arbitrarily moved horizontally linearly, vertically linearly, diagonally linearly, circularly, irregularly or in any other similar manner.

In accordance with one embodiment, with a circularly shaped screen and/or support frame, a circular movement of the screen with respect to the support frame around the center of the screen can occur. While performing such a circular movement of the screen with respect to the support frame, it is possible to maintain a predetermined direction of rotation.

In accordance with a particularly preferred embodiment, it is possible to move the screen with respect to the support frame at a predetermined oscillation amplitude and oscillation frequency, or rotational frequency. To prevent an interference with the view because of the strips between the individual holes in the screen, the value of the oscillation amplitude can correspond at least to one-half of the distance between two holes in the screen, measured in the direction of the oscillation.

The movement of the screen with respect to the support frame can be predetermined at an oscillation frequency of approximately 1 to 50 oscillations per second. A grid-shaped screen is almost invisible at an oscillation frequency of approximately 20 oscillations per second and is perceived by the human eye merely as a gray shade.

If the value of the oscillation amplitude is increased, the value of the oscillation frequency can be reduced without causing a substantial interference with the see-through or viewing ability as a result.

The support frame preferably is at least partially of a metal or a similar material impenetrable to microwaves. To assure a particularly good shielding from the microwave radiation, the support frame can cover the screen at least in its edge area at least around one side.

A particularly good shielding effect is achieved because the screen is conducted in a U-shaped recess extending at least partially around the support arm. Also, with such an arrangement the screen can be fixed in place particularly dependably within the range of movement of its oscillation amplitude.

For effective shielding it can be necessary to provide at least one flexible, electrically conductive connection between the support frame and the screen.

Good movement ability of the screen on the support frame is assured because the screen is movably fixed on the support frame by at least one elastic support element.

The at least one support element is embodied in a particularly advantageous manner as a metallic, electrically conductive spring element. With such a step, a connection with good electrical conducting properties is realized at the same time.

In one preferred embodiment, a motor is a drive unit, which acts together with an eccentric disk or similar eccentric drive mechanism. With these steps it is possible to put the screen into oscillating movements in a simple manner.

A particularly energy-saving embodiment provides that the eccentric disk or the eccentric drive mechanism is connected with the screen via at least one resilient connecting element for generating the oscillating movements with the resonance frequency of the screen.

### BRIEF DESCRIPTION OF THE DRAWINGS

This invention is explained in view of preferred embodiments, making reference to the attached drawings, wherein:

FIG. 1 shows a door of a microwave device in accordance with a first embodiment, in a schematic plan view and in section;

FIG. 2 shows an observation window in accordance with this invention in a schematic plan view and in section taken along the section line II-II of the embodiment shown in FIG. 1;

FIG. 3 shows a door of a microwave device in accordance with a further embodiment of the observation window in accordance with this invention, in a schematic plan view and in section;

FIG. 4 shows a partial area of a screen with a grid of holes as it can be employed in connection with the observation window in accordance with this invention;

FIG. 5 is a schematic top view of a door for a microwave device in accordance with still another embodiment, wherein the observation window is embodied round; and

FIG. 6 shows the observation window in accordance with the embodiment shown in FIG. 5 but in a schematic plan view and in section taken along section line VI-VI as shown in FIG. 5.

### DESCRIPTION OF PREFERRED EMBODIMENTS

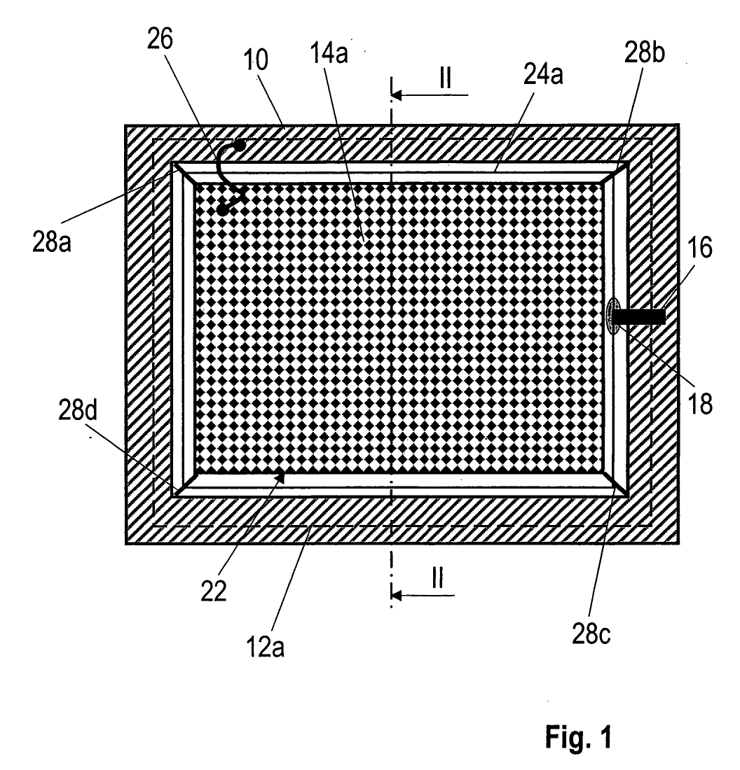

An observation window, such as is used in connection with the door of a microwave device but not shown in the drawings, is shown in a schematic plan view and in section in FIG. 1. The observation window has an essentially rectangular support frame 10 made of a profiled metal piece. On the side facing the observer, a transparent cover plate 12a made of glass is attached to the support frame 10 and is shown in dashed lines in FIG. 1. The cover plate 12a is used to close off the cooking chamber of the microwave device.

A metallic screen 14a, which is impermeable to microwaves, is “stretched” inside the support frame 10. The screen 14a extends substantially parallel with the cover plate 12a and substantially includes a metal plate with a hole pattern cut into it. The screen 14a is movably seated by elastic support elements 28a, 28b, 28c and 28d in the four corner areas of the support frame 10. In the embodiment shown in FIG. 1, the support elements 28a, 28b, 28c and 28d are embodied as elastic plastic elements that make an electrically non-conductive connection between the screen 14a and the support frame 10. However, for shielding the microwave radiation occurring in the cooking chamber of the microwave device, the screen 14a must be connected in an electrically conducting manner with the support frame 10, and the latter with the body, not shown, of the microwave device. A flexible conducting element 26 is arranged between the screen 14a and the support frame 10 for this purpose. The conducting element 26 makes an electrically conductive connection between the screen 14a and the support frame 10.

So that the view of the observer can be directed nearly unhindered through the screen to the material to be cooked located in the cooking chamber of the microwave device, the screen 14a is oscillatingly moved. Thus, an electric motor 16 which drives an eccentric disk 18 is arranged on the side of the support frame 10, on the right as shown in FIG. 1. The eccentric disk 18 rests against the side area of the screen 14a on the right as shown in FIG. 1 so that the movement of the eccentric disk 18 puts the screen 14a into motion. Here the eccentric disk 18 is designed so that the oscillation amplitude which, in the embodiment represented in FIG. 1 extends in a horizontal direction, corresponds to at least one-half the distance between two holes in the metal plate embodied as the screen 14a. During such a movement the eye of the observer hardly notices the interference with the view by the strips between the holes, so that small details also become visible.

The movement of the screen occurs with some oscillations per second, wherein starting at approximately 20 oscillations per second the grid becomes nearly invisible to an observer and is only visible as a gray shade. Therefore the screen 14a can be moved at an oscillation frequency from 1 to approximately 50 oscillations per second. The oscillation frequency is preferably greater than or equal to 20 oscillations per second.

Alternatively to an oscillating movement in a preferred direction, it is also possible to drive the screen 14a to make irregular movements.

When the microwave device is switched on, the electric motor 16 is driven, so that the view of the observer is clear during the cooking process. Following the switch-off of the microwave device, the electric motor 16 is also switched off.

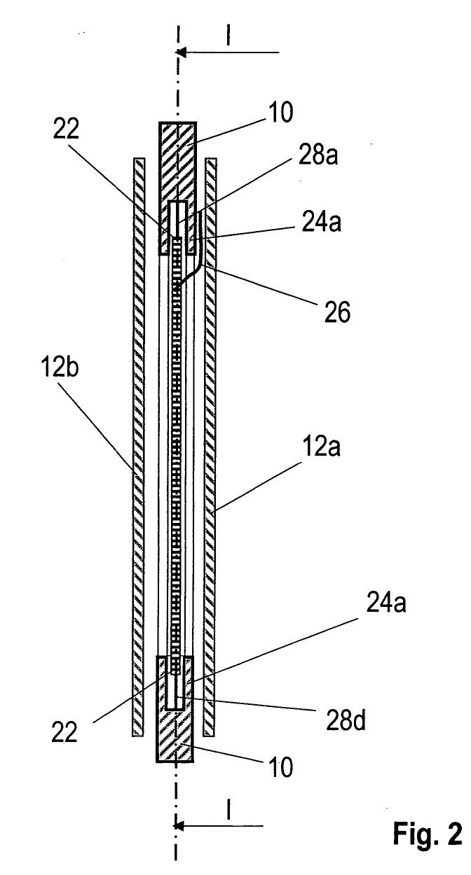

FIG. 2 shows a sectional view of the observation window represented in FIG. 1 taken along the section line II-II. In this sectional view the screen 14a extends vertically, wherein the lower and upper end areas of the screen 14a are movably fixed on the support frame 10. The elastic support element 28d connects the screen 14a with the support frame 10 in the upper edge area.

In order to achieve a particularly effective shielding of the microwave radiation in the cooking chamber of the microwave device, the area of the support frame 10 facing the screen 14a extends around the screen 14a in a U shape. This U-shaped recess 24a encircles the entire edge area of the screen 14a. The horizontal distance in FIG. 1 between the edge area 22 of the screen 14a and the U-shaped recess 24a is selected to be relatively small, preferably equal to 0.1 mm, for reasons of shielding.

Alternatively, the edge area 22 of the screen 14a can also be covered by the support frame 10 only on one side, for example in an L-shape.

As shown in FIG. 2, the glass cover plate 12a mentioned in connection with FIG. 1 extends along the lateral face of the screen 14 which is shown at the right in FIG. 2. The cover plate is used for closing the cooking chamber off. On the other lateral face of the screen 14a, as shown to the left in FIG. 2, a further transparent cover plate 12b extends also parallel with the screen 14a. This is also made of glass. The cover plate 12b is used for protecting the screen 14a against unintentional touching by the user.

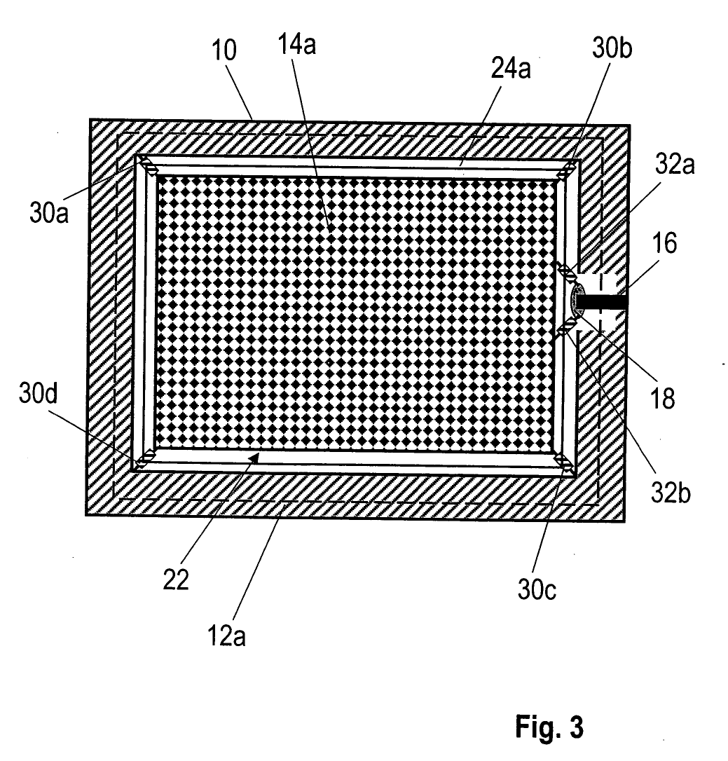

FIG. 3 shows a sectional view of a further embodiment of an observation window, such as also employed for being inserted into a door of a microwave device. In contrast to the embodiment represented in FIG. 1, the screen 14a is movably fixed in place by spring elements 30a, 30b, 30c and 30d, which are attached at the corner areas between the screen 14a and the support frame 10. The resilient elements are made of an electrically conductive material in the form of helical springs. Thus, the elastic support elements 30a, 30b, 30c and 30d additionally take on the job of an electrically conductive connection with the support frame 10, in addition with the elastic suspension of the screen 14a. Thus, a dependable shielding against microwaves is assured. As stated in greater detail in view of FIG. 2, the area of the support frame 10 facing the screen 14a extends all around the edge area of the screen 14a, so that an effective shielding is thus assured.

The screen 14a in accordance with the embodiment represented in FIG. 3 is caused to resonate. Thus, the eccentric disk 18 connected with the motor 16 is also connected with the screen 14a by resilient connecting elements 32a and 32b embodied as helical springs.

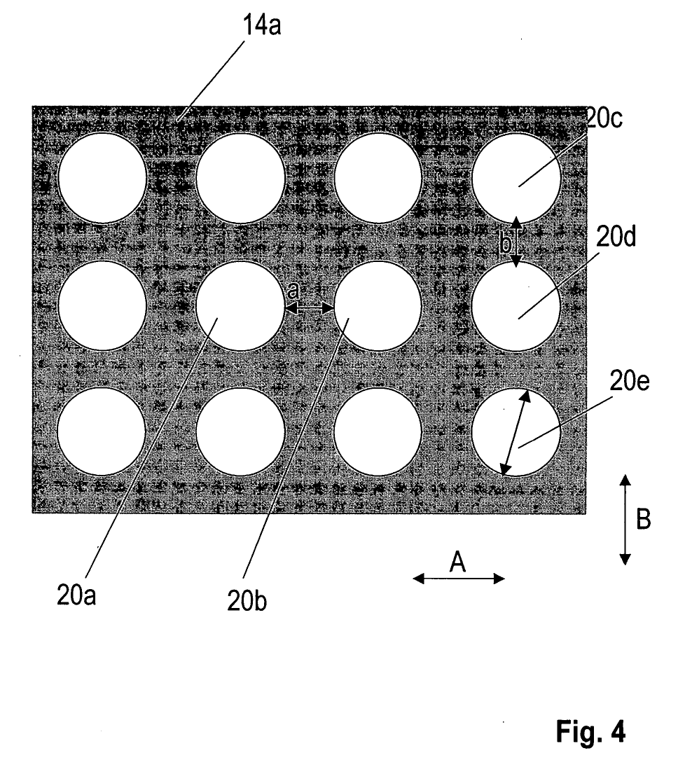

FIG. 4 shows a partial area of the screen 14a, wherein the arrangement of holes in the mentioned metal plate is explained in greater detail. In the embodiment represented in FIG. 4, the holes have a diameter d of approximately 1 mm as made clear by hole 20e. The distance between two holes, for example the distance a between the holes 20a and 20b, and the distance b between the holes 20c and 20d is matched to the oscillation amplitude of the screen 14a. Thus, the oscillation amplitude of an oscillation in the direction of the two-headed arrow A is at least one-half the distance (a/2) between the holes 20a and 20b. Accordingly, the oscillation amplitude in the direction of the two-headed arrow B amounts to at least one-half the distance (b/2) between the holes 20c and 20d. This requirement applies in particular at an oscillation frequency of some oscillations per second.

If, however, the oscillation amplitude in the direction of the two-headed arrow A is selected to be greater than one-half the distance (a/2) between the holes 20a and 20b, then the movement frequency of the screen 14a in the direction of the two-headed arrow A can be reduced, since only the number of holes moved past the line of sight of the observer is important for increasing the ability to view.

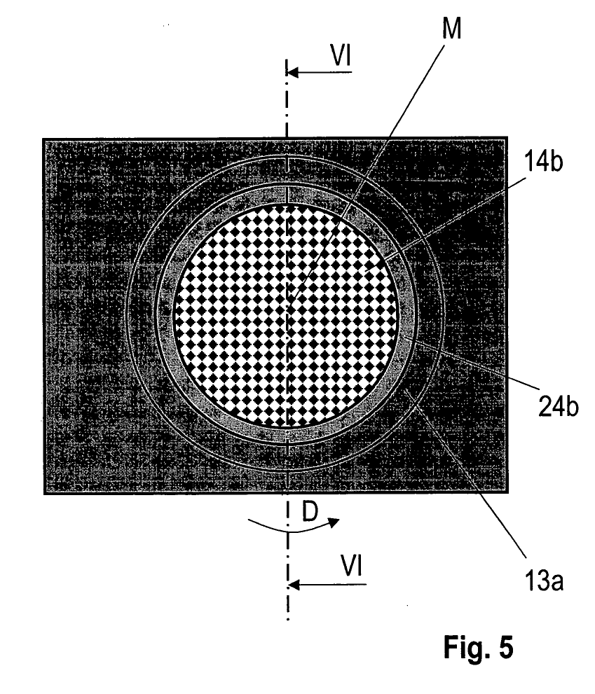

FIG. 5 shows a schematic top view on a circular observation window, such as used in the door of a microwave device. In this case the support frame 10 is embodied so that it has a circular recess for receiving the circularly embodied screen 14b in its interior area. The glass cover plate 13a is also embodied round.

The screen 14b is rotated around the center M in the direction of the arrow D by an electric motor, not shown. The edge area 24b facing the screen 14b surrounds the associated edge area of the screen 14b all around in a U-shape.

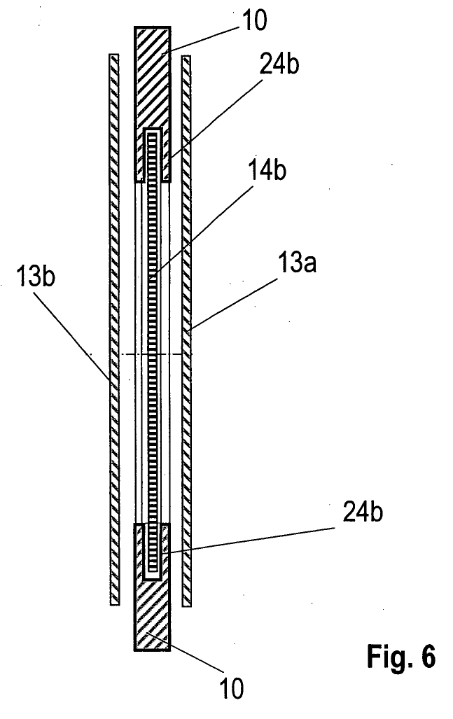

FIG. 6 shows a sectional view of the observation window represented in FIG. 5. Here, the U-shaped surrounding of the edge area 24b of the support frame 10 around the edge area of the screen 14b becomes clear. The screen 14b is guided within the U-shaped recess 24b on the support frame, wherein ball bearings, not shown, can be used, for example. An electric motor drives the circular screen 14b, for example via a gear wheel system.

An electrically conductive connection, not shown, is provided between the screen 14b and the support frame 10, which can be provided, for example, inside the U-shaped recess 24b. Wiper contacts may be employed here, for example.

It is possible with the observation window in accordance with this invention to permit the observer a view of the interior of a microwave device, which to a large degree is unhampered.

German Patent Reference 103 06 882.1, filed Feb. 19, 2003, the priority document corresponding to this invention, and its teachings are incorporated, by reference, into this specification.

What is claimed is:

1. An observation window for a chamber exposed to microwaves, having a support frame (10) and at least one transparent cover plate (12a, 12b, 12c, 12d) affixed to the support frame (10) for closing off the chamber, wherein the at least one cover plate (12a, 12b, 12c, 12d) is covered on at least one side with a metallic screen (14a, 14b), which is impenetrable to microwaves, the observation window comprising:
the screen (14a, 14b) movably seated with respect to the support frame (10) and to increase an ability to view through the screen (14a, 14b) a drive mechanism (16, 18) moving the screen (14a, 14b).

2. The observation window in accordance with claim 1, wherein the screen (14a, 14b) is one of a lattice grid, a metal plate with a grid of holes (20a, 20b, 20c, 20d) and an open-worked flat arrangement piece.

3. The observation window in accordance with claim 2, wherein at least one of the screen (14a, 14b), the cover plate (12a, 12b, 12c, 12d) and the support frame (10) is formed at least one of rectangular, round and in any other arbitrary form, at least in parts.

4. The observation window in accordance with claim 2, wherein the screen (14a, 14b) is arbitrarily movable one of horizontally linearly, vertically linearly, diagonally linearly, circularly, irregularly and in any like manner.

5. The observation window in accordance with claim 4, wherein with at least one of the circularly shaped screen (14b) and the support frame (10), a circular movement of the screen with respect to the support frame (10) around a center (M) of the screen occurs.

6. The observation window in accordance with claim 5, wherein while performing a circular movement of the screen (14b) with respect to the support frame (10) a predetermined direction of rotation (D) is maintained.

7. The observation window in accordance with claim 6, wherein the screen (14a, 14b) is movable with respect to the support frame (10) at a predetermined oscillation amplitude and one of an oscillation frequency and a rotational frequency.

8. The observation window in accordance with claim 7, wherein a value of the oscillation amplitude corresponds at least to one-half of a distance (a, b) between two holes (20a, 20b, 20c, 20d) in the screen (14a) measured in a direction of an oscillation (A, B).

9. The observation window in accordance with claim 8, wherein the oscillation frequency is predetermined as a value of approximately 1 to 50 oscillation per second.

10. The observation window in accordance with claim 9, wherein the oscillation frequency is predetermined as a value of one of greater than and equal to 20 oscillations per second.

11. The observation window in accordance with claim 10, wherein when the oscillation amplitude is increased, a value of the oscillation frequency is reduced.

12. The observation window in accordance with claim 11, wherein the support frame (10) is at least partially of one of a metal and a similar material impenetrable to microwaves.

13. The observation window in accordance with claim 12, wherein the support frame (10) covers the screen (14a, 14b) at least in an edge area (20) at least around one side.

14. The observation window in accordance with claim 13, wherein the screen (14a, 14b) is conducted in a U-shaped recess (24a, 24b) extending at least partially around the support arm (10).

15. The observation window in accordance with claim 14, wherein at least one flexible, electrically conductive connection (26) is between the support frame (10) and the screen (14a).

16. The observation window in accordance with claim 15, wherein the screen (14a) is movably fixed on the support frame (10) by at least one elastic support element (28a, 28b, 28c, 28d; 30a, 30b, 30c, 30d).

17. The observation window in accordance with claim 16, wherein the at least one support element is embodied as a metallic, electrically conductive spring element (30a, 30b, 30c, 30d).

18. The observation window in accordance with claim 17, wherein the drive mechanism has a motor (16), which acts together with one of an eccentric disk (18) and an eccentric drive mechanism to oscillate the screen (14a, 14b).

19. The observation window in accordance with claim 18, wherein one of the eccentric disk (18) and the eccentric drive mechanism is connected with the screen (14a, 14b) by at least one resilient connecting element (32a, 32b) for generating the oscillating movements with the resonance frequency of the screen (14a, 14b).

20. The observation window in accordance with claim 1, wherein at least one of the screen (14a, 14b), the cover plate (12a, 12b, 12c, 12d) and the support frame (10) is formed at least one of rectangular, round and in any other arbitrary form, at least in parts.

21. The observation window in accordance with claim 1, wherein the screen (14a, 14b) is arbitrarily movable one of horizontally linearly, vertically linearly, diagonally linearly, circularly, irregularly and in any like manner.

22. The observation window in accordance with claim 3, wherein with at least one of the circularly shaped screen (14b) and the support frame (10), a circular movement of the screen with respect to the support frame (10) around a center (M) of the screen occurs.

23. The observation window in accordance with claim 1, wherein the screen (14a, 14b) is movable with respect to the support frame (10) at a predetermined oscillation amplitude and one of an oscillation frequency and a rotational frequency.

24. The observation window in accordance with claim 7, wherein the oscillation frequency is predetermined as a value of approximately 1 to 50 oscillation per second.

25. The observation window in accordance with claim 7, wherein the oscillation frequency is predetermined as a value of one of greater than and equal to 20 oscillations per second.

26. The observation window in accordance with claim 9, wherein when the oscillation amplitude is increased, a value of the oscillation frequency is reduced.

27. The observation window in accordance with claim 1, wherein the support frame (10) is at least partially of one of a metal and a similar material impenetrable to microwaves.

28. The observation window in accordance with claim 1, wherein the screen (14a, 14b) is conducted in a U-shaped recess (24a, 24b) extending at least partially around the support arm (10).

29. The observation window in accordance with claim 1, wherein at least one flexible, electrically conductive connection (26) is between the support frame (10) and the screen (14a).

30. The observation window in accordance with claim 1, wherein the screen (14a) is movably fixed on the support frame (10) by at least one elastic support element (28a, 28b, 28c, 28d; 30a, 30b, 30c, 30d).

31. The observation window in accordance with claim 1, wherein the drive mechanism has a motor (16), which acts together with one of an eccentric disk (18) and an eccentric drive mechanism to oscillate the screen (14a, 14b).
